(19) United States
(12) Patent Application Publication
(10) Pub. No.: US 2005/0160405 A1
(43) Pub. Date: Jul. 21, 2005

(54) System and method for generating code coverage information

(75) Inventors: Pankaj S. Lunia, Redmond, WA (US); Nathan E. Nesbit, Duvall, WA (US); Kenneth K. Ma, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/760,757

(22) Filed: Jan. 20, 2004

(51) Int. Cl. G06F 9/44

(52) U.S. Cl. 717/124

(57) ABSTRACT

A system and method for instrumenting a software build to automatically generate code coverage data without the use of external code coverage tools is presented. A software build is generated. The software build is independently executable. The software build is then instrumented to automatically generate code coverage data when executed. The instrumented software is executable independent of any external code coverage tools.

### FIELD OF THE INVENTION

The present invention relates to computer software, and in particular, computer software for generating code coverage information in regard to a software build.

### BACKGROUND OF THE INVENTION

For both the consumer and the software provider, discovering software problems or flaws in a released product can be disastrous. Thus, a key phase of a software development cycle is testing the software to ensure that the released product is error free. However, as software programs increase in complexity and size, software testing becomes increasingly more difficult, and time and resource consuming. Many software applications today are the result of millions of lines of code, and testing such applications can be an onerous task. Accordingly, many testing tools have been developed to assist software providers in testing their products.

One tool used to test a software product is a code coverage tool. The idea behind code coverage tools is to determine whether a particular area of code has been executed. As an area of code cannot be said to be tested if it has not yet been exercised, code coverage information is important. In particular, code coverage tools generate information that enable software providers to track when and how often an area of code has been executed. By examining the data generated by the code coverage tool, a determination can be made as to which areas of the product were not exercised and still need to be tested. Thus, tracking whether an area of code has been executed, especially during a testing phase, is an important part of producing quality software products. The more a software provider is assured that all areas of the application have been tested/exercised, the more sure the software provider is that the application is error free. Unfortunately, current code coverage tools are difficult to operate, and preparing a software build to generate code coverage data requires significant tester intervention.

To better understand how current code coverage tools operate, FIG. 2 presents a block diagram illustrating a typical process 200 for using code coverage tools to generate coverage data for a software application. Source files 202 are processed in a special build process 204 to generate an intermediate build 210. The build process 204 typically involves several steps or passes. As shown in FIG. 2, at least one step is to compile or assemble the source files 202. As part of this step, someone, such as a tester or code manager, must select the source files for which code coverage data is to be generated. In other words, current code coverage tools generate code coverage data only for specific files that have been properly processed for generating code coverage data. Thus, as indicated in FIG. 2, some source files are processed by the code coverage compilation 206, while the others are processed by a standard compilation 208.

After the intermediate build has been generated, an instrumentation process 212 generates an instrumented build 214 for generating the code coverage data for the selected source files. Unfortunately, the instrumented build 214 is a non-standard build and is not useful of itself, for several reasons. For instance, instrumented builds, such as instrumented build 214, are quite large in comparison to standard, non-instrumented builds. Additionally, the instrumentation process added references to libraries and routines that are not part of the instrumented build 214, but instead are found in a code coverage tool 216. These libraries and subroutines include facilities to register, log, and report the code coverage data 218 generated by the instrumented build 210. Thus, due at least in part to its size and external references, the instrumented build 214 can only be executed in conjunction with the code coverage tool 216, as illustrated by the combined code coverage tool/instrument build execution block 218. In short, instrumented builds cannot be used in the same manner as a non-instrumented, “retail” product.

Using the current code coverage process 200 raises several real issues in regard to software testing. As already mentioned, getting a build generated, operating, and generating code coverage data requires technical expertise from a user. Additionally, because the instrumented build 214 is executing in conjunction with the code coverage tool 216, issues related to memory usage by the instrumented build 214 are not the same as when a corresponding non-instrumented build is executed. Thus, software problems that exist in regard to memory usage may not be discovered when using an instrumented build 214. Furthermore, it is often difficult, if not impossible, to run automated test processes on the instrumented build 210, as the code coverage tool 210 is executing 218 the instrumented build 214.

Yet further issues regarding current code coverage tools arise in regard to operating systems. Current code coverage tools must be executed on a functioning operating system. Unfortunately, in regard to operating systems, this creates a so-called “catch-22.” Simply put, current code coverage tools cannot operate on an instrumented operating system build because current code coverage tools need a functional operating system to be running.

What is needed is a system and method for generating code coverage data in regard to a software build that does not require an additional code coverage tool for execution. The system and method should also permit code coverage information to be generated without requiring substantial user administration or expertise. The present invention addresses these and other issues found in the prior art.

### SUMMARY OF THE INVENTION

A method for generating code coverage data for a software build is presented. A software build is generated from source code. The software build is independently executable. The software build is instrumented such that the instrumented software build, when executed, automatically generates code coverage data. Further, the instrumented software build is executable independent of external code coverage tools. The instrumented software build is then executed to generate the code coverage data.

A method for creating an instrumented software build for automatically generating code coverage data is presented. A software build is obtained. The software build is independently executable. The software build is instrumented such that the instrumented software build, when executed, automatically generates code coverage data. The instrumented software build is executable independent of external code coverage tools.

A computer system for instrumenting a software build to automatically generate code coverage data is presented. The computer system comprises a processor and a memory. In operation, the computer system obtains a software build, wherein the software build is independently executable. After obtaining the software build, the computer system instruments the software build such that, when executed, the instrumented software build automatically generates code coverage data. The instrumented software build is independently executable of external code coverage tools.

A method for creating an instrumented software build for automatically generating code coverage data is presented. Source code for the software build is obtained. An instrumented software build is generated using build tools specially adapted to generate the instrumented software build from the source code. The instrumented software build, when executed, automatically generates code coverage data. Further, the instrumented software build is independently executable of any external code coverage tools.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary computing environment suitable for implementing aspects of the present invention;

FIG. 2 is a block diagram illustrating a prior art process for using current code coverage tools to generate coverage data for a software build;

FIG. 3A is a block diagram illustrating an exemplary process for generating code coverage data in accordance with the present invention;

FIG. 3B is a block diagram illustrating an alternative exemplary process for generating code coverage data in accordance with aspects of the present invention;

FIG. 4 is a flow diagram illustrating an exemplary method for generating code coverage data in accordance with the present invention;

FIG. 5 is a flow diagram illustrating an alternative method for generating code coverage data in accordance with the present invention; and

FIG. 6 is a flow diagram illustrating an exemplary method for generating a code coverage build in accordance with the present invention.

### DETAILED DESCRIPTION

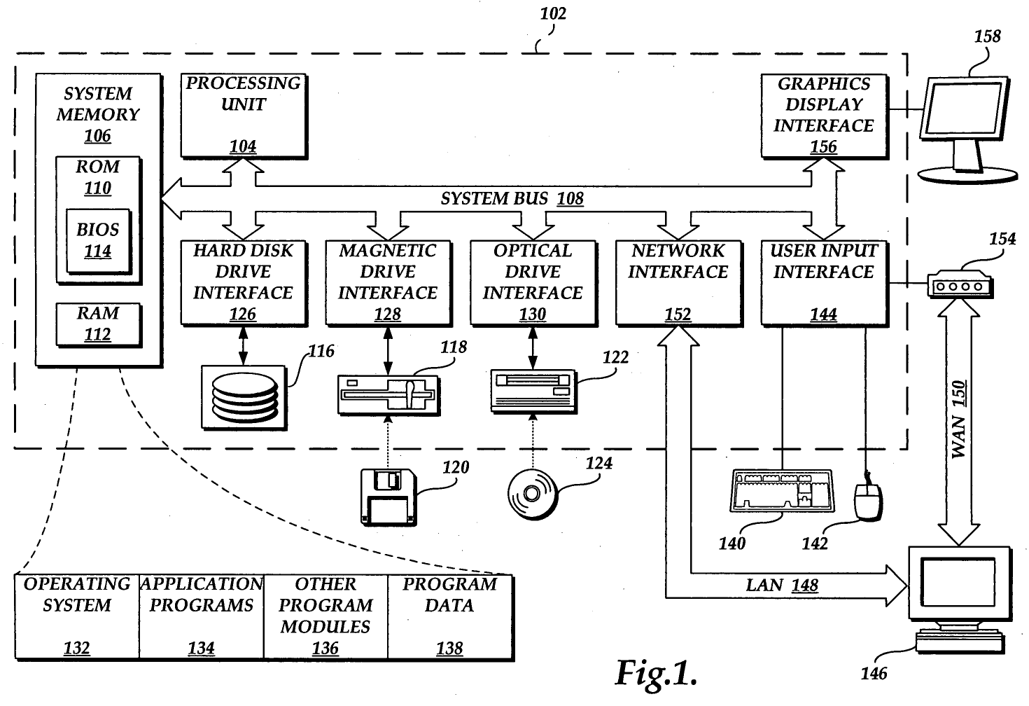

FIG. 1 and the following discussion are intended to provide a brief, general description of a computing system suitable for implementing various features of the invention. While the computing system will be described in the general context of a personal computer usable as a stand-alone computer, or in a distributed computing environment where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, and the like.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc., that perform particular tasks or implement particular abstract data types.

With reference to FIG. 1, an exemplary system for implementing aspects of the invention includes a conventional personal computer 102, including a processing unit 104, a system memory 106, and a system bus 108 that couples the system memory to the processing unit 104. The system memory 106 includes read-only memory (ROM) 110 and random-access memory (RAM) 112. A basic input/output system 114 (BIOS), containing the basic routines that help to transfer information between elements within the personal computer 102, such as during startup, is stored in ROM 110.

The personal computer 102 further includes a hard disk drive 116, a magnetic disk drive 118, e.g., to read from or write to a removable disk 120, and an optical disk drive 122, e.g., for reading a CD-ROM disk 124 or to read from or write to other optical media. The hard disk drive 116, magnetic disk drive 118, and optical disk drive 122 are connected to the system bus 108 by a hard disk drive interface 126, a magnetic disk drive interface 128, and an optical drive interface 130, respectively. The drives and their associated computer-readable media provide nonvolatile storage for the personal computer 102. Although the description of computer-readable media above refers to a hard disk, a removable magnetic disk, and a CD-ROM disk, it should be appreciated by those skilled in the art that other types of media that are readable by a computer, including magnetic cassettes, flash memory cards, digital video disks, Bernoulli cartridges, ZIP disks, and the like, may also be used in the exemplary operating environment.

A number of program modules may be stored in the drives and RAM 112, including an operating system 132, one or more application programs 134, other program modules 136, and program data 138. A user may enter commands and information into the personal computer 102 through input devices such as a keyboard 140 or a mouse 142. Other input devices (not shown) may include a microphone, touch pad, joystick, game pad, satellite dish, scanner, or the like. These and other input devices are often connected to the processing unit 104 through a user input interface 144 that is coupled to the system bus, but may be connected by other interfaces (not shown), such as a game port or a universal serial bus (USB).

A display device 158 is also connected to the system bus 108 via a display subsystem that typically includes a graphics display interface 156 and a code module, sometimes referred to as a display driver, to interface with the graphics display interface. While illustrated as a stand-alone device, the display device 158 could be integrated into the housing of the personal computer 102. Furthermore, in other computing systems suitable for implementing the invention, such as a tablet computer, the display could be overlaid with a touch-screen. In addition to the elements illustrated in FIG. 1, personal computers also typically include other peripheral output devices (not shown), such as speakers or printers.

The personal computer 102 may operate in a networked environment using logical connections to one or more remote computers, such as a remote computer 146. The remote computer 146 may be a server, a router, a peer device, or other common network node, and typically includes many or all of the elements described relative to the personal computer 102. The logical connections depicted in FIG. 1 include a local area network (LAN) 148 and a wide area network (WAN) 150. Such networking environments are commonplace in offices, enterprise-wide computer networks, intranets, and the Internet. It should be appreciated that the connections between one or more remote computers in the LAN 148 or WAN 150 may be wired or wireless connections, or a combination thereof.

When used in a LAN networking environment, the personal computer 102 is connected to the LAN 148 through a network interface 152. When used in a WAN networking environment, the personal computer 102 typically includes a modem 154 or other means for establishing communications over the WAN 150, such as the Internet. The modem 154, which may be internal or external, is connected to the system bus 108 via the user input interface 144. In a networked environment, program modules depicted relative to the personal computer 102, or portions thereof, may be stored in the remote memory storage device. It will be appreciated that the network connections shown are exemplary and other means of establishing a communication link between the computers may be used. In addition, the LAN 148 and WAN 150 may be used as a source of nonvolatile storage for the system.

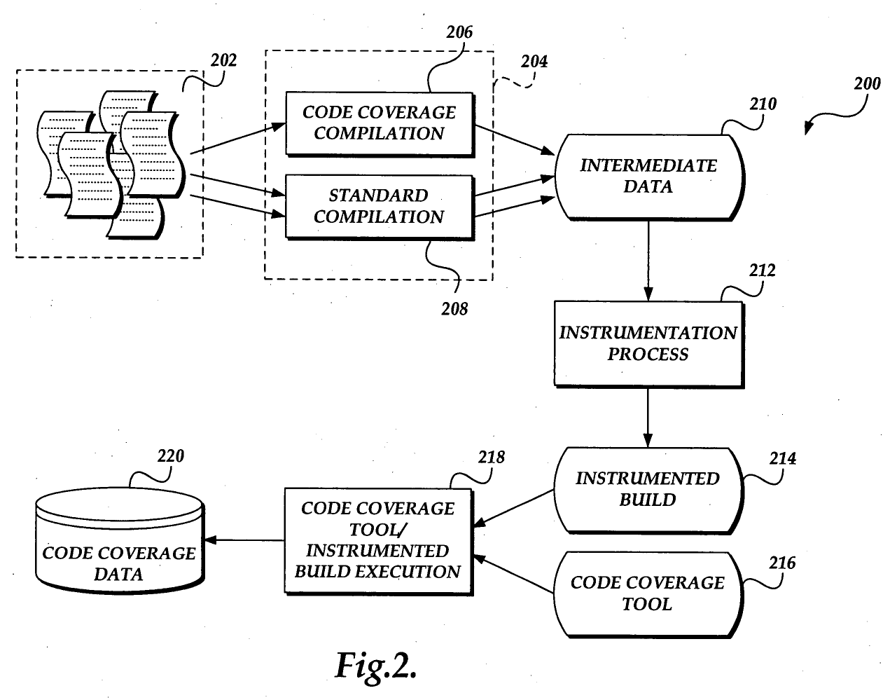

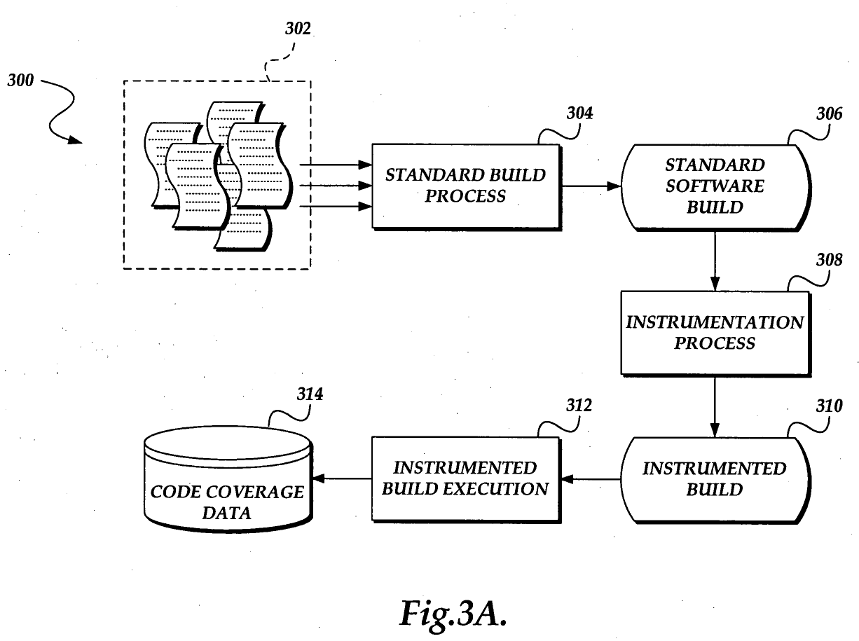

In contrast to the prior art process 200 described above for generating code coverage information, FIG. 3A is a block diagram illustrating an exemplary process 300 for generating code coverage data for a software build in accordance with aspects of the present invention. In accordance with the exemplary process 300, source files 302 first pass through a standard build process 304, resulting in an intermediate build 306. The intermediate build 306 is then processed in an instrumentation process 308 that adds code coverage information to the entire software build, resulting in instrumented build 310. In contrast to the prior art solutions described above, the instrumented build 310 is independently executable, i.e., can be executed by itself, without the “assistance” of additional code coverage tools, such as code coverage tool 216 (FIG. 2). Thus, the instrumented build 310 is executed 312, and as the instrumented build executes, it generates code coverage data 314 for the entire software build.

A significant advantage realized by the present invention is that a tester does not use any additional code coverage tools to generate code coverage data. Indeed, a tester is longer involved with selecting source modules for code coverage, generating an instrumented build, or learning how to use a special code coverage tool. Instead, a tester can focus on testing the particular product, and is not distracted by the code coverage tools. Additionally, because the instrumented build 310 is independently executable, it may be distributed to beta test sites, or even to customers, who can use the instrumented build in their normal operations and transparently generate code coverage data for the entire build, without any additional tools. According to aspects of the present invention, an instrumented build 310 may be configured to transparently transmit code coverage data over the Internet to the software provider, which can be used and analyzed to locate difficult-to-identify problems in the software product that testers or customers experience.

According to FIG. 3A, the instrumentation process 310 operates on a standard software build 306. By instrumenting the software build 306 after it has been generated, standard build tools may be used. However, the present invention should not be construed as limited to operating on generated software builds. For example, build tools with the ability to generate an instrumented software build may be used, thereby eliminating the extra step of instrumenting a standard software build. FIG. 3B illustrates an alternative exemplary process 320 for generating code coverage data 216 using such tools.

According to this alternative exemplary process 320, source files 302 are processed in a build/instrumentation process 322 using specially adapted build tools, thereby directly generating an instrumented build 322. Thus, in contrast to the exemplary process 300 of FIG. 3A, the specially adapted build tools are adapted to add code coverage functionality into the software build. As the result, instrumented build 310 is available for execution 324, and upon execution, will generate code coverage data 314. Additionally, the entire software build may be instrumented to generate code coverage data. According to aspects of the present invention, the instrumentation process can instrument any size of application, including very large applications such as entire operating systems.

As those skilled in the art will recognize, there are various ways to implement code coverage instrumentation. More particularly, code coverage information may be based on a routine level, source line level, and block level. Routine level instrumentation tracks the code from a routine level, such that all of the code in the routine is considered executed if the routine is called. Source line level instrumentation tracks the code corresponding to individual lines of source code, such that the code corresponding to that source line is considered executed if any of the code is executed. Alternatively, block level instrumentation tracks code according to linear, non-branching sequences (blocks) of instructions. Blocks are delineated by branches and jumps/gotos in the code. Thus, because a block is a linear sequence of code, if a block is entered, the entire block will be executed as there are no branches or jumps in that block to prevent their execution. According to one embodiment of the present invention, a software build is instrumented on a block level. If a software build is first generated and then instrumented, such as described in regard to FIG. 3A, the instrumentation process analyzes the software build, identifies the various blocks, and adds the code coverage functionality to those blocks to generate the code coverage data. Alternatively, during the build process, the specially adapted build tools identify the blocks and directly add the code coverage functionality.

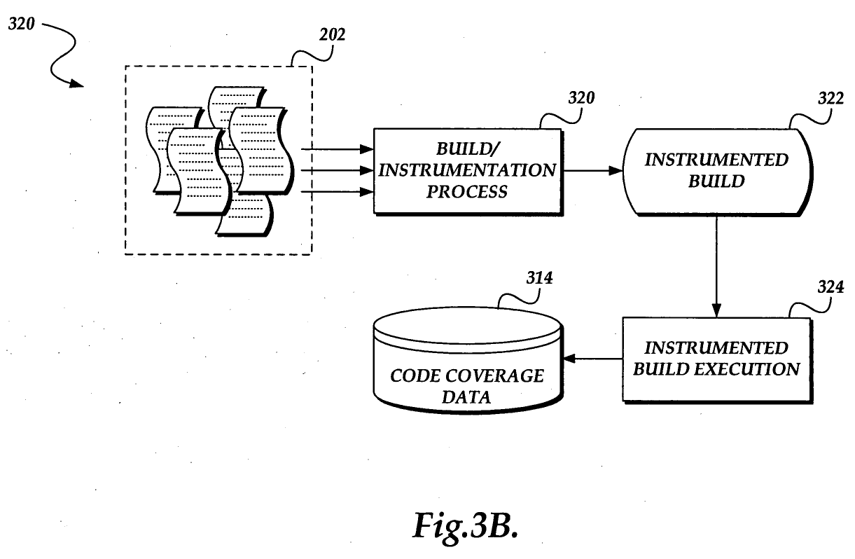

FIG. 4 is a flow diagram illustrating an exemplary method for generating code coverage data. Beginning at block 402, the source files for the software application are obtained. At block 404, a software build 210 is generated. At block 406, the software build is instrumented to automatically generate code coverage data. After generating the instrumented software build 310, at block 408, the instrumented software build is executed. As previously discussed, during execution the instrumented software build 310 automatically generates code coverage data which, at block 410, is recorded. Thereafter, the routine 400 terminates.

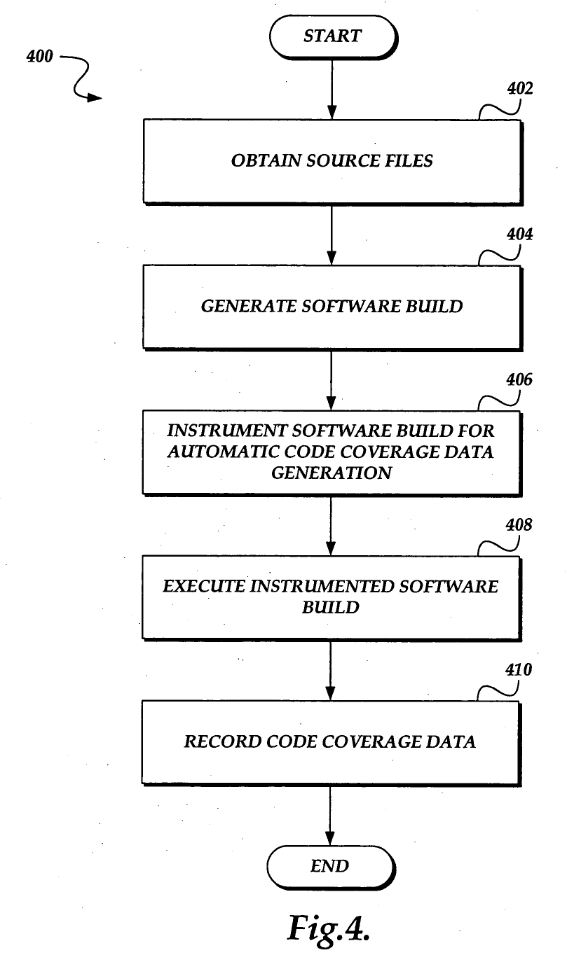

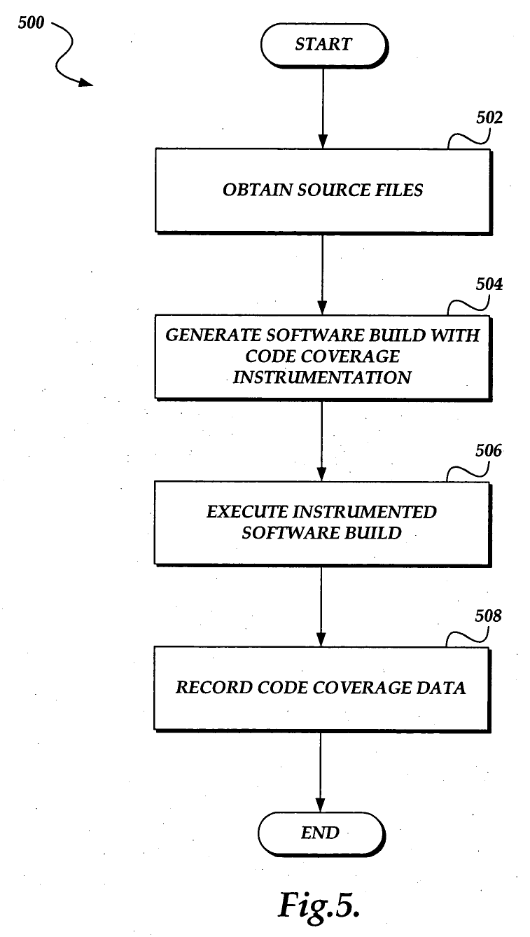

FIG. 5 is a flow diagram illustrating an exemplary alternative routine 500 for generating code coverage data. Beginning at block 502, the software source files are obtained. At block 504, the source files are processed by a build process using build tools that are specially adapted to not only generate an instrumented software build 310, such that the instrumented software build automatically generates code coverage data 314. At block 506, the instrumented software build 310 is executed. As the instrumented software build 310 is executed, the instrumented software build automatically generates code coverage data 314. At block 608, the code coverage data 314, generated by the instrumented software build 310, is recorded. Thereafter, the routine 500 terminates.

While the preferred embodiment of the invention has been illustrated and described, it will be appreciated that various changes can be made therein without departing from the spirit and scope of the invention.

1. A computer implemented method for generating code coverage data for a software build, the method comprising:
generating a software build from source code, the software build being independently executable;
instrumenting the software build such that the instrumented software build, when executed, will automatically generate code coverage data, wherein the instrumented software build is executable independent of external code coverage tools; and
executing the instrumented software build.

2. The method of claim 1, wherein the software build is a software build of an operating system.

3. The method of claim 1, wherein the software build is instrumented on a block level.

4. The method of claim 1, wherein the entire software build is instrumented to generate code coverage data.

5. The method of claim 1 further comprising delivering the instrumented software build to a user, and wherein the instrumented software build is executed by a user.

6. A method for creating an instrumented software build for automatically generating code coverage data, the method comprising:
obtaining a software build, the software build being independently executable; and
instrumenting the software build such that the instrumented software build, when executed, automatically generates code coverage data;
wherein the instrumented software build is executable independent of external code coverage tools.

7. The method of claim 6, wherein the software build is a software build of an operating system.

8. The method of claim 6, wherein the software build is instrumented on a block level.

9. The method of claim 6, wherein the entire software build is instrumented to generate code coverage data.

10. A computer-readable medium bearing computer-executable instructions which, when executed on a computer, carry out a method for generating code coverage data for a software build, the method comprising:
generating a software build from source code, the software build being independently executable;
instrumenting the software build such that the instrumented software build, when executed, will automatically generate code coverage data, wherein the instrumented software build is executable independent of external code coverage tools; and
executing the instrumented software build.

11. The method of claim 10, wherein the software build is a software build of an operating system.

12. The method of claim 10, wherein the software build is instrumented on a block level.

13. The method of claim 10, wherein the entire software build is instrumented to generate code coverage data.

14. The method of claim 10 further comprising delivering the instrumented software build to a user, and wherein the instrumented software build is executed by a user.

15. A computer-readable medium bearing computer-executable instructions which, when executed on a computer, carry out a method for creating an instrumented software build for automatically generating code coverage data, the method comprising:
generating a software build from source code, the software build being independently executable; and
instrumenting the software build such that the instrumented software build, when executed, automatically generates code coverage data;
wherein the instrumented software build is executable independent of external code coverage tools.

16. The method of claim 15, wherein the software build is a software build of an operating system.

17. The method of claim 15, wherein the software build is instrumented on a block level.

18. The method of claim 15, wherein the entire software build is instrumented to generate code coverage data.

19. A computer system for instrumenting a software build to automatically generate code coverage data, the system comprising:
a processor; and
a memory;
wherein the computer system is operable to:
obtain a software build, the software build being independently executable; and
instrument the software build such that the instrumented software build, when executed, automatically generates code coverage data, and wherein the instrumented software build is executable independent of external code coverage tools.

20. The computer system of claim 19, wherein the software build is a software build of an operating system.

21. The computer system of claim 19, wherein the computer system instruments the software build on a block level.

22. The computer system of claim 19, wherein the computer system instruments the entire software build to generate code coverage data.

23. A method for creating an instrumented software build for automatically generating code coverage data, the method comprising:
obtaining the source code for the software build;
generating an instrumented software build from the source code using build tools specially adapted to generate an instrumented software build, wherein the instrumented software build being executable independent of any external code coverage tools, and wherein the instrumented software build, when executed, automatically generates code coverage data.

24. The method of claim 23, wherein the instrumented software build is an instrumented software build of an operating system.

25. The method of claim 23, wherein the build tools instrument the software build on a block level.

26. The method of claim 23, wherein the build tools instrument the entire software build to automatically generate code coverage data.
